(19) United States
(12) Patent Application Publication
(10) Pub. No.: US 2024/0126275 A1
(43) Pub. Date: Apr. 18, 2024

(54) OBSTACLE AVOIDANCE SYSTEM AND METHOD FOR UNMANNED VEHICLE

(71) Applicant: aiseed Inc., Taipei City (TW)

(72) Inventors: Tsung-Yuan Wang, Taipei City (TW); Chih-Ting Li, Taipei City (TW); Shou-Hsien Wang, Taipei City (TW)

(21) Appl. No.: 18/376,857

(22) Filed: Oct. 5, 2023

(30) Foreign Application Priority Data
Oct. 14, 2022 (TW) 111138937

(51) Int. Cl. G05D 1/10; B64U 20/80

(52) U.S. Cl. CPC G05D 1/106; B64U 20/80; B64U 2201/10

(57) ABSTRACT

The present invention is directed to an obstacle avoidance system for an unmanned vehicle, comprising: an obstacle sensing module provided at a vehicle body; a vehicle-mounted computer provided at the vehicle body and electrically connected to the obstacle sensing module; a control module provided at the vehicle body and electrically connected to the vehicle-mounted computer; and a power source provided at the vehicle body and electrically connected to the obstacle sensing module, the vehicle-mounted computer and the control module. Where, the obstacle sensing module provides sensed information to the vehicle-mounted computer, the vehicle-mounted computer judges whether time for at least one obstacle to approach the vehicle body is less than a safe value according to the information, and if the time is less than the safe value, the vehicle-mounted computer calculates a collision time sequence of the obstacles and plans a movement trajectory, and communicates modified trajectory information to the control module, and the control module controls the vehicle body to perform an obstacle avoidance movement according to the modified trajectory information.

### REFERENCE TO RELATED APPLICATIONS

The present application is based on, and claims priority from, Taiwan application number 111138937, filed 2022 Oct. 14, the disclosure of which is hereby incorporated by reference herein in its entirety.

### BACKGROUND OF THE INVENTION

### Field of the Invention

The present invention is directed to an obstacle avoidance system and method for an unmanned vehicle, and in particular to an obstacle avoidance system and method which can enable the unmanned vehicle to avoid an obstacle when moving.

### Description of the Prior Art

When an existing unmanned aerial vehicle flies or moves, the unmanned aerial vehicle may collide with an external obstacle. After a collision occurs, the unmanned aerial vehicle may be damaged or seriously destructed depending on situations. Therefore, obstacle avoidance for the unmanned aerial vehicle becomes an important subject.

An existing obstacle avoidance system for the unmanned aerial vehicle mostly employs an autopilot. In an existing autopilot architecture, an obstacle avoidance function may be achieved by a simple distance sensor in a multi-axis rotor wing mode. When the sensor senses that the obstacle is within a set range, an aircraft switches to a hovering mode. If path planning is considered, the vehicle-mounted computer must be provided to collect point clouds containing depth information in a surrounding environment. In a case of a fixed-wing flight, the aircraft cannot hover, the speed per second of the common fixed-wing flight is 20 msec (70 km/hr) or more, and a detection distance of a depth-of-field camera for point clouds containing depth information has referential property only when a detection distance is within a short distance (within 10 meters), so that the current autopilot cannot support the obstacle avoidance function of the high-speed aircraft.

In summary, since the existing autopilot cannot support obstacle avoidance for the high-speed aircraft, it becomes an urgent project to be improved in the industry.

### SUMMARY OF THE INVENTION

In view of various shortcomings of the above-mentioned prior art, after years of research and experimentation, the present inventor has finally succeeded in developing and completing an obstacle avoidance system and method for an unmanned vehicle of the present invention.

The present invention discloses an obstacle avoidance system for an unmanned vehicle, comprising an obstacle sensing module, a vehicle-mounted computer, a control module and a power source. The obstacle sensing module is provided at a vehicle body. The vehicle-mounted computer is provided at the vehicle body and electrically connected to the obstacle sensing module. The control module is provided at the vehicle body and electrically connected to the vehicle-mounted computer. The power source is provided at the vehicle body and electrically connected to the obstacle sensing module, the vehicle-mounted computer and the control module.

Where, the obstacle sensing module provides sensed information to the vehicle-mounted computer, the vehicle-mounted computer judges whether time for at least one obstacle to approach the vehicle body is less than a safe value according to the information, and if the time is less than the safe value, the vehicle-mounted computer calculates a collision time sequence of the obstacles and plans a movement trajectory, and communicates modified trajectory information to the control module, and the control module controls the vehicle body to perform an obstacle avoidance movement according to the modified trajectory information.

In an embodiment, the obstacle sensing module is a millimeter-wave radar.

In an embodiment, a navigation sensing module is provided at the vehicle body and electrically connected to the control module.

In an embodiment, the navigation module is a global navigation satellite system, an inertial measurement unit, a magnetic navigation component or a barometer.

In an embodiment, a communication module is provided at the vehicle body and electrically connected to the control module and the power source.

The present invention also discloses an obstacle avoidance method for an unmanned vehicle, comprising the steps of:
detecting an obstacle in front: sensing, by an obstacle sensing module, the front of the vehicle body of an unmanned vehicle, and providing sensed information to a vehicle-mounted computer;
performing obstacle collision processing according to the time sequence of approaching the vehicle body and whether time for at least one obstacle to approach the vehicle body is greater than or equal to the safe value: calculating, by the vehicle-mounted computer, whether the time for the at least one obstacle to approach the vehicle body is greater than or equal to the safe value according to the information; if not, proceeding to the next step;
planning an obstacle avoidance route: calculating, by the vehicle-mounted computer, a collision time sequence of the obstacles and planning a movement trajectory according to the information; and
performing obstacle avoidance: communicating, by the vehicle-mounted computer, modified trajectory information to a control module, and controlling, by the control module, the vehicle body to perform an obstacle avoidance movement.

In an embodiment, in the step of performing the obstacle collision processing according to the time sequence of approaching the vehicle body and whether the time for the at least one obstacle to approach the vehicle body is greater than or equal to the safe value, if so, proceed to a step of maintaining an original route, in which the control module still maintains the vehicle body in the original route according to original route setting.

According to the obstacle avoidance system and method for the unmanned vehicle, the obstacle sensing module senses the obstacles in front of the vehicle body of the unmanned aerial vehicle, the vehicle-mounted computer judges whether the time for at least one obstacle to approach the vehicle body is less than the safe value, and if the time is less than the safe value, the vehicle-mounted computer calculates a collision time sequence of the obstacles and plans a movement trajectory, and communicates the modified trajectory information to the control module. The control module controls the vehicle body to perform an obstacle avoidance movement according to the modified trajectory information.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 is a schematic view of an obstacle avoidance system for an unmanned vehicle of the present invention;

FIG. 2 is a schematic flow chart of an obstacle avoidance method for the unmanned vehicle.

### DETAILED DESCRIPTION OF THE INVENTION

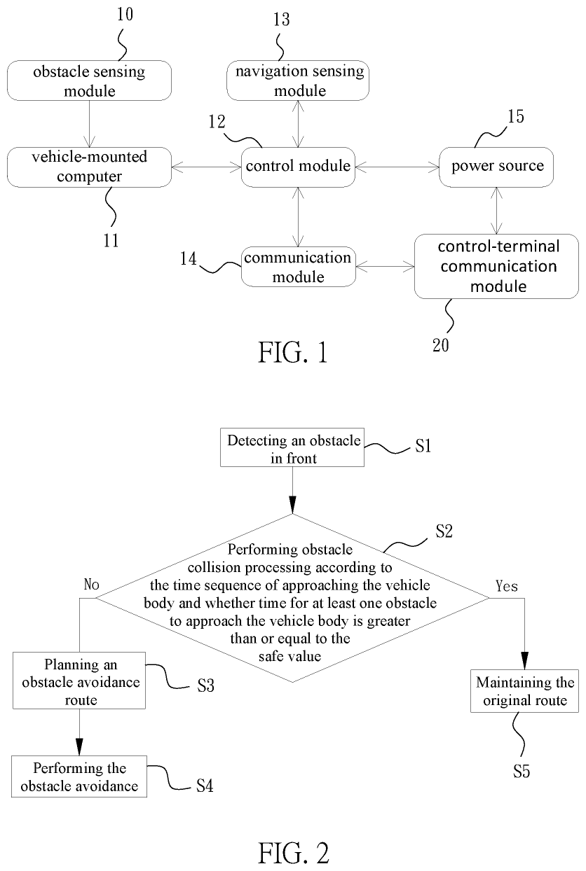

Referring to FIG. 1, FIG. 1 shows a schematic view of an obstacle avoidance system for an unmanned vehicle of the present invention. As shown, the obstacle avoidance system for the unmanned vehicle of the present invention comprises an obstacle sensing module 10, a vehicle-mounted computer 11, a control module 12, a navigation sensing module 13, a communication module 14 and a power source 15.

The obstacle sensing module 10 is provided at a vehicle body of the unmanned vehicle. The unmanned vehicle may be an aerial, terrestrial, surface-type or underwater unmanned vehicle, but is not limited thereto. The obstacle sensing module 10 may be a millimeter-wave radar.

The vehicle-mounted computer 11 is provided at a vehicle body and electrically connected to the obstacle sensing module 10. With regards to path planning of the vehicle-mounted computer 11, path planning with the minimum cost is to be found on the premise of conforming to a cost function of a steady-state design of the unmanned vehicle.

The control module 12 is provided at the vehicle body, and the control module 12 is electrically connected to the vehicle-mounted computer 11. The navigation sensing module 13 is provided at the vehicle body and the navigation sensing module 13 is electrically connected to the control module 12. The navigation sensing module 13 may be a global navigation satellite system (GNSS), an inertial measurement unit (IMU), a magnetic navigation component or a barometer. For example, the navigation sensing module 13 sets planning of an original route before the unmanned vehicle moves.

The communication module 14 is electrically connected to the control module 12. The communication module 14 is further electrically connected to a control-terminal communication module 20, for receiving instructions from a control terminal, such as instructions for providing an original movement route plan (an original route) to the navigation sensing module 13, changing the route of the vehicle body (a new route) or changing a movement of the vehicle body.

The power source 15 is electrically connected to the obstacle sensing module 10, the vehicle-mounted computer 11, the control module 12, the navigation sensing module 13 and the communication module 14, so as to provide power to the obstacle sensing module 10, the vehicle-mounted computer 11, the control module 12, the navigation sensing module 13 and the communication module 14. The power source 15 is a rechargeable battery, a fuel cell, a solar cell and any device that can provide power.

Since the obstacle sensing module 10 is the millimeter-wave radar which can provide a detection distance of 60-200 m or a field of view (FOV, according to radar specifications) of 30-60 degrees to detect birds, flying objects and obstacles, an effect of distant early warning is achieved.

The obstacle sensing module 10 provides sensed information to the vehicle-mounted computer 11, the vehicle-mounted computer 11 judges whether time for at least one obstacle to approach the vehicle body is less than a safe value according to the information provided by the obstacle sensing module 10, and if the time is less than the safe value, the vehicle-mounted computer 11 calculates a collision time sequence of obstacles (if a plurality of obstacles exist) and plans a movement trajectory and communicates modified trajectory information to the control module 12 and the navigation sensing module 13. The coordinates (set points) of a modified trajectory are coordinates of an origin relative to the vehicle body. The navigation sensing module 13 and the control module 12 control the vehicle body to perform an obstacle avoidance movement according to the modified trajectory information.

Referring to FIG. 2, FIG. 2 shows a schematic flow chart of an obstacle avoidance method for an unmanned vehicle of the present invention. As shown, the obstacle avoidance method for the unmanned vehicle of the present invention comprises the following steps.

Step S1, detecting an obstacle in front: sensing the front of the vehicle body of the unmanned vehicle, and providing sensed information to the vehicle-mounted computer 11, by the obstacle sensing module 10.

Step S2, performing obstacle collision processing according to the time sequence of approaching the vehicle body and whether time for at least one obstacle to approach the vehicle body is greater than or equal to the safe value: calculating, by the vehicle-mounted computer 11, whether the time for the obstacle to approach the vehicle body is greater than or equal to the safe value according to the information provided by the obstacle sensing module 10. For example, a relative speed of an obstacle A and an unmanned vehicle may result in differences in the time for approaching the unmanned vehicle at a same distance, e.g., when the unmanned vehicle is flying at a speed of 25 m/s and the obstacle A is at a relative distance of 100 meters, at this time, if the obstacle A is static and has a speed of 0 m/s, 4 seconds are left for the unmanned vehicle to make a plan. If an obstacle B also moves towards the unmanned vehicle at 25 m/s, only 2 seconds are left for the unmanned vehicle to respond, in which case the obstacle B would be processed more preferentially than the obstacle A after the collision time is sequenced. It is assumed that the safe value is 2-4 seconds. If not, that is, the time for the obstacle B to approach the vehicle body is less than the safe value, proceed to Step S3. If so, that is, the time for the obstacle B to approach the vehicle body is greater than or equal to the safe value, proceed to Step S5.

Step S3, planning an obstacle avoidance route: calculating a collision time sequence of the obstacles (if a plurality of obstacles exist) and planning a movement trajectory, by the vehicle-mounted computer 11 according to the information provided by the obstacle sensing module 10.

Step S4, performing the obstacle avoidance: communicating, by the vehicle-mounted computer 11, the modified trajectory information to the control module 12 and the navigation sensing module 13. The coordinates (set points) of a modified trajectory are coordinates of an origin relative to the vehicle body. The navigation sensing module 13 and the control module 12 control the vehicle body to perform an obstacle avoidance movement according to the modified trajectory information.

For example, the basic principles of obstacle avoidance in path planning are as follows: if an obstacle is approaching the unmanned vehicle directly from the front, the unmanned vehicle pitches up; if an obstacle is approaching the unmanned vehicle from the right front, the unmanned vehicle rolls left; if an obstacle is approaching the unmanned vehicle from the left front, the unmanned vehicle rolls right.

Step S5, maintaining the original route: still maintaining, by the control module 12, the vehicle body in the original route according to original route setting provided by the navigation sensing module 13.

In summary, according to the obstacle avoidance system and method for the unmanned vehicle, the obstacle sensing module 10 senses the obstacles in front of the vehicle body of the unmanned aerial vehicle, the vehicle-mounted computer 11 judges whether the time for at least one obstacle to approach the vehicle body is less than the safe value, and if the time is less than the safe value, the vehicle-mounted computer 11 calculates a collision time sequence of the obstacles and plans a movement trajectory, and communicates the modified trajectory information to the control module 12 and the navigation sensing module 13. The control module 12 controls the vehicle body to perform an obstacle avoidance movement according to the modified trajectory information.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An obstacle avoidance system for an unmanned vehicle, comprising:
an obstacle sensing module provided at a vehicle body;
a vehicle-mounted computer provided at the vehicle body and electrically connected to the obstacle sensing module;
a control module provided at the vehicle body and electrically connected to the vehicle-mounted computer; and
a power source provided at the vehicle body and electrically connected to the obstacle sensing module, the vehicle-mounted computer and the control module;
wherein the obstacle sensing module provides sensed information to the vehicle-mounted computer, the vehicle-mounted computer judges whether time for at least one obstacle to approach the vehicle body is less than a safe value according to the information, and if the time is less than the safe value, the vehicle-mounted computer calculates a collision time sequence of the obstacles and plans a movement trajectory, and communicates modified trajectory information to the control module, and the control module controls the vehicle body to perform an obstacle avoidance movement according to the modified trajectory information.

2. The obstacle avoidance system for the unmanned vehicle of claim 1, wherein the obstacle sensing module is a millimeter-wave radar.

3. The obstacle avoidance system for the unmanned vehicle of claim 1, comprising a navigation sensing module provided at the vehicle body and electrically connected to the control module.

4. The obstacle avoidance system for the unmanned vehicle of claim 3, wherein the navigation sensing module is a global navigation satellite system, an inertial measurement unit, a magnetic navigation component or a barometer.

5. The obstacle avoidance system for the unmanned vehicle of claim 4, comprising a communication module provided at the vehicle body and electrically connected to the control module and the power source.

6. An obstacle avoidance method for an unmanned vehicle, comprising the steps of:
detecting an obstacle in front: sensing, by an obstacle sensing module, the front of the vehicle body of an unmanned vehicle, and providing sensed information to a vehicle-mounted computer;
performing obstacle collision processing according to the time sequence of approaching the vehicle body and whether time for the at least one obstacle to approach the vehicle body is greater than or equal to the safe value: calculating, by the vehicle-mounted computer, whether the time for the at least one obstacle to approach the vehicle body is greater than or equal to the safe value according to the information; if not, proceeding to the next step;
planning an obstacle avoidance route: calculating a collision time sequence of the obstacles and planning a movement trajectory, by the vehicle-mounted computer according to the information; and
performing obstacle avoidance: communicating, by the vehicle-mounted computer, modified trajectory information to a control module, and controlling, by the control module, the vehicle body to perform an obstacle avoidance movement.

7. The obstacle avoidance method for the unmanned vehicle of claim 6, wherein in the step of performing the obstacle collision processing according to the time sequence of approaching the vehicle body and whether the time for the at least one obstacle to approach the vehicle body is greater than or equal to the safe value, if so, proceed to a step of maintaining an original route, in which the control module still maintains the vehicle body in the original route according to original route setting.
